(19) United States
(12) Patent Application Publication
(10) Pub. No.: US 2015/0273405 A1
(43) Pub. Date: Oct. 1, 2015

(54) FLUID SEPARATION UNIT

(71) Applicant: 3M INNOVATIVE PROPERTIES COMPANY, Saint Paul, MN (US)

(72) Inventors: John W. Henderson, St. Paul, MN (US); Brady P. Haislet, Maple Plain, MN (US); Brent R. Hansen, New Richmond, WI (US); Jonathan F. Hester, Hudson, WI (US); Gregory M. Jellum, Marine on St. Croix, MN (US); Qihong Nie, Woodbury, MN (US); John F. Reed, North Oaks, MN (US); John B. Scheibner, Woodbury, MN (US); David F. Slama, City of Grant, MN (US); Steven E. Turch, Blaine, MN (US)

(21) Appl. No.: 14/428,831

(22) PCT Filed: Sep. 17, 2013
(86) PCT No.: PCT/US13/60024

§ 371 Date: Mar. 17, 2015

Related U.S. Application Data
(60) Provisional application No. 61/702,942, filed on Sep. 19, 2012.

(51) Int. Cl. B01D 71/68; B01D 19/00; B01D 67/00; B01D 71/10; B01D 71/34; B01D 71/58; B01D 71/50; B01D 71/26; B01D 71/38; B01D 71/32; B01D 53/22; B01D 71/56

(52) U.S. Cl. CPC B01D 71/68; B01D 53/228; B01D 19/0031; B01D 67/0002; B01D 71/10; B01D 71/56; B01D 71/58; B01D 71/50; B01D 71/26; B01D 71/38; B01D 71/32; B01D 71/34; B01D 2053/221

(57) ABSTRACT

Described herein is a membrane separation module and articles and methods thereof, wherein the membrane separation module has a series of repeating layers, each layer comprising (a) a selectively permeable membrane; and (b) at least one support layer, wherein the support layer comprises a plurality of flow channels and a plurality of rails extending from the support layer, wherein the sides of two adjacent rails form a flow channel, wherein the plurality of rails on the support layer comprise a thermoplastic polymer at the distal end of at least a portion of the plurality of rails, and wherein the distal end of the plurality of rails contacts the selectively permeable membrane to form a bonded stack.

### TECHNICAL FIELD

The present disclosure generally relates to a membrane separation module. More specifically, the present disclosure relates to a fluid separation construction useful in tangential flow filtration, including microfiltration, and ultrafiltration; membrane bioreactors; membrane aeration bioreactors; membrane-assisted liquid-liquid extraction or solvent extraction; liquid gasification or degasification; gas humidification or dehumidification; selective gas separation; membrane distillation; and other filtration and mass transfer apparatus.

### BACKGROUND

Liquids can be filtered with a plurality of filter modules that are stacked between manifolds or individually sealed to a manifold plate. Each module includes one or more filter layers separated by spacer layers, which permit liquid feed to flow into the apparatus as well as filtrate to flow from the apparatus. Filtration within the module can be conducted as a tangential flow filtration, where incoming feed liquid is flowed tangentially over a membrane surface to form a retentate and a filtrate.

In these types of devices, where there are multiple outlets and/or fluid streams it is important to seal the fluid streams from one another.

U.S. Pat. No. 4,264,447 (Nicolet), discloses providing an ultrafiltration membrane between a porous sheet and backing plate. The porous sheet and backing plate are heat sealed together such that the ultrafiltration membrane is mechanically joined therein.

Typically periphery or edge seals between the support layer and the filtration membrane have been used. See for example, U.S. Pat. Nos. 5,651,888 (Shimizu et al.); and 6,287,467 (Nagano et al.).

### SUMMARY

There is a desire to provide a membrane separation module having, for example, improved mechanical and dimensional stability and/or are more cost effective to manufacture.

In one aspect, a membrane separation module is provided comprising: a series of repeating layers, each layer comprising (a) a selectively permeable membrane; and (b) at least one support layer, wherein the support layer comprises a plurality of flow channels and a plurality of rails extending from the support layer, wherein the sides of two adjacent rails form a flow channel, wherein the plurality of rails on the support layer comprise a thermoplastic polymer at the distal end of at least a portion of the plurality of rails, and wherein the distal end of the plurality of rails contacts the selectively permeable membrane to form a bonded stack.

In one embodiment, the membrane support module comprises at least two support layers.

In one aspect, an article is provided comprising a membrane separation module comprising: a series of repeating layers, each layer comprising (a) a selectively permeable membrane; and (b) at least one support layer, wherein the support layer comprises a plurality of flow channels and a plurality of rails extending from the support layer, wherein the sides of two adjacent rails form a flow channel, wherein the plurality of rails on the support layer comprise a thermoplastic polymer at the distal end of at least a portion of the plurality of rails, and wherein the distal end of the plurality of rails contacts the selectively permeable membrane to form a bonded stack.

In yet another aspect, a method of making an article is provided comprising (a) providing a selectively permeable membrane and at least one support layer, wherein the support layer comprises a plurality of flow channels and a plurality of rails extending from the support layer, wherein the sides of two adjacent rails form a flow channel, wherein the plurality of rails on the support layer comprise a thermoplastic polymer at the distal end of at least a portion of the plurality of rails; (b) contacting the distal end of the plurality of rails to the selectively permeable membrane to form a layer; (c) stacking a plurality of the layers; and (d) applying heat to bond the distal end of the plurality of rails to the selectively permeable membrane to form a bonded stack.

The above summary is not intended to describe each embodiment. The details of one or more embodiments of the invention are also set forth in the description below. Other features, objects, and advantages will be apparent from the description and from the claims.

### BRIEF DESCRIPTION OF DRAWINGS

FIG. 1 is an exploded perspective view of a membrane separation module according to one embodiment of the present disclosure;

FIGS. 2a and 2b is an exploded perspective view and side view, respectively, of a support layer according to one embodiment of the present disclosure;

FIGS. 3a and 3b are exploded perspective views of support layers according to two different embodiments of the present disclosure;

FIG. 4 is an exploded perspective view of a support layer according to one embodiment of the present disclosure;

FIGS. 5a, 5b, and 5c are exploded perspective views illustrating three different embodiments of the present disclosure for assembling the membrane separation module;

FIGS. 6 and 7 are exploded perspective views of finished membrane separation modules according to embodiments of the present disclosure;

FIG. 8 is a perspective view of a fluid distribution cap and a housing to hold a membrane separation module according to one embodiment of the present disclosure; and

FIG. 9 is a perspective view of a fluid distribution cap according to one embodiment of the present disclosure.

### DETAILED DESCRIPTION

As used herein, the terms

“a”, “an”, and “the” are used interchangeably and mean one or more; and

“and/or” is used to indicate one or both stated cases may occur, for example A and/or B includes (A and B) and (A or B).

As used herein, the term “microporous” refers to porous films, membranes or film layers having an average pore size of 0.05 to 3.0 microns as measured by bubble point pore size ASTM-F-316-03 (2011) “Standard Test Methods for Pore Size Characteristics of Membrane Filters by Bubble Point and Mean Flow Pore Test”.

As used herein, the term “ultraporous” refers to films, membranes or film layers having an average pore size of up to 10 micrometers, or 0.001 to 0.05 micrometers as measured by bubble point pore size test ASTM-F-316-03 (2011).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The present disclosure provides membrane separation modules and articles using the same for filtering and/or extracting desired or undesired constituents. In the present disclosure, the separation module comprises a selectively permeable membrane and a plurality of support layers. The support layer comprises a plurality of rails, which define the sides of flow channels. A thermoplastic polymer is located at the distal end of at least a portion of the plurality of rails and is used to bond the support layer to a selectively permeable membrane and/or isolate the flow channels from each other.

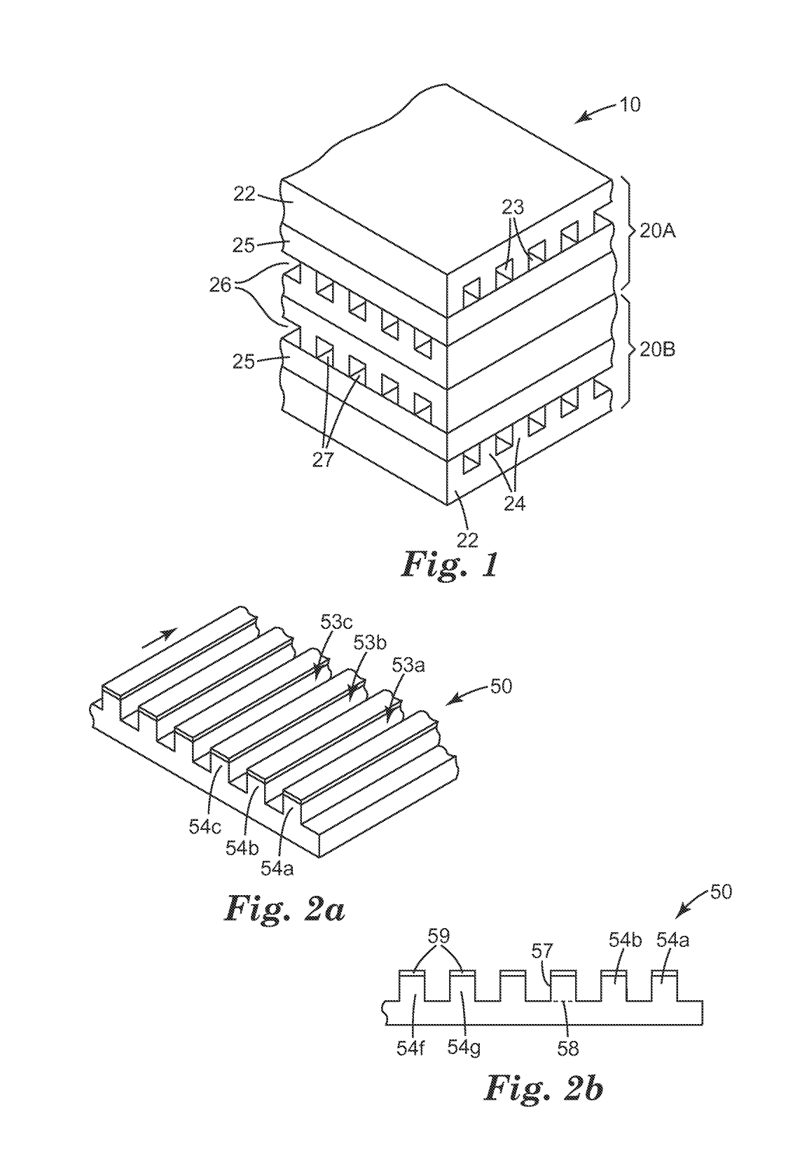

FIG. 1 depicts an exemplary membrane separation module. Membrane separation module 10 comprises a series of repeating layers. Shown in FIG. 1 are two layers 20A and 20B, wherein each layer comprises selectively permeable membrane 25, and at least one support layer. Support layer 22 comprises a plurality of flow channels 23 and a plurality of rails 24. The sides of adjacent rails form the flow channels. The plurality of flow channels 27 of support layer 26 have a direction of flow different than that of the plurality of flow channels 23 of support layer 22.

Selectively Permeable Membrane

The selectively permeable membrane is used to provide a membrane for selective passage or transport of at least one constituent of a fluid mixture through the structure while selectively precluding transport of other constituent(s). Exemplary selectively permeable membranes include microporous membranes, ultraporous membranes, non-woven webs, woven webs, perforated or micro-perforated polymer films, and the like. When using multiple layers of the selectively permeable membrane, each layer may be the same or different depending on the application. For example, the selectively permeable membrane can comprise a porous membrane and a fibrous or non-woven layer.

The selectively permeable membrane may be hydrophilic or hydrophobic depending on the requirements of separation, such as gas-solid, gas-liquid, gas-gas, liquid-solid, or liquid-liquid separation requirements. Some non-exhaustive examples of materials that may be used as part of the selectively permeable membrane include: polysulfones, polyethersulfones, cellulose polymers, polyamides (e.g., nylon), polycarbonate, polyolefins (e.g., polypropylene, polyethylene), ethylene vinyl alcohol copolymer, polyvinyl chloride, fluoropolymers (e.g., polyvinylidene fluoride, ethylene-chlorotrifluoroethylene copolymers, polytetrafluoroethylene), polyacrylonitrile, composites of ionic polymers containing ionic liquids, such as those disclosed in U.S. Pat. Publ. No. 2012/0186446 (Bara et al.), or any copolymers or other combinations thereof. In one embodiment, the surface of the membrane is treated (e.g., coated) to provide additional surfaces properties (such as hydrophobicity, or selectivity to a certain compound).

In one embodiment, the selectively permeable membrane may be ultraporous or microporous with pore sizes that may range from about 0.001 μm (micrometer) to about 10 μm. Preferably, the pore size of the selectively permeable membrane is less than about 3.0 μm.

In one embodiment, the selectively permeable membrane is a non-woven. Exemplary non-wovens include: blown microfiber (BMF) filter media, which typically has 1-10 μm fiber size; nanofiber filter media, which can be produced by a BMF process or electrospinning process and typically has a fiber size less than 1 μm; and spunbond filter media, which are typically greater than 10 μm fiber size. Spunbond media can be laminated to (or co-formed with) BMF or nanofiber media to give a composite with increased strength.

BMF, nanofiber, and spunbond nonwoven media can be produced out of a variety of polymers such as for example, polyolefins, polyesters, nylons, and other polymers.

In another embodiment, the selectively permeable membrane may be a perforated (e.g., a highly perforated film) polymeric film. In one embodiment, highly perforated films are made by embossing polymeric films to form cavities within the film, which are then subject to flame treatment to form highly perforated thin films (e.g., 50-800 micrometers or even 75 to 250 micrometers). Such a method is disclosed in U.S. Pat. Appl. No. 61/285,102 (Scheibner et al.), herein incorporated by reference in its entirety. These highly perforated films may be oriented in a particular configuration to take advantage of the film's tapered hole geometry. Further, because these films are thin, have a high percentage of open area, and/or a high density of perforations, pressure drops across the films can be lowered, which is advantageous in filtration applications.

In one embodiment, the perforated polymeric film comprises (i) opposed first and second surfaces; and (ii) a plurality of channels perpendicular to the first and second surfaces, wherein a first opening of each channel intersects the first surface and a second opening of each channel intersects the second surface; wherein the diameter of the first opening is larger than the diameter of the second opening; wherein the second surface has an open area of at least 20%, 40%, 50%, or even 60%; and further wherein the second surface comprises at least 1,000; 3,000; or even 6,000 openings per square inch.

In another embodiment, the perforated polymeric film comprises (i) opposed first and second surfaces separated by a first certain distance; and (ii) a plurality of channels perpendicular to the first and second surfaces, wherein a first opening of each channel intersects the first surface and a second opening of each channel intersects the second surface; wherein the diameter of the first opening is larger than the diameter of the second opening and the second openings on the second surface are spaced apart by a second certain distance; wherein the ratio of the first certain distance to the second certain distance is at least 0.25, 0.5, 1, 2, 3, or even 3.5; and further wherein the second surface has an open area of at least 10%, 20%, 40%, or even 60%.

The thickness of the selectively permeable membrane can vary depending on the application. In one embodiment, the thickness of the selectively permeable membrane is at least 10 μm, 20 μm, 25 μm, 30 μm, 35 μm or even 40 μm; at most 75 μm, 100 μm, 125 μm, 150 μm or even 200 μm, depending on the application.

Support Layer

The support layer of the present disclosure is used to provide structural support to the membrane separation module and provide conveyance of fluid (e.g., liquid) to and/or from the selectively permeable membrane.

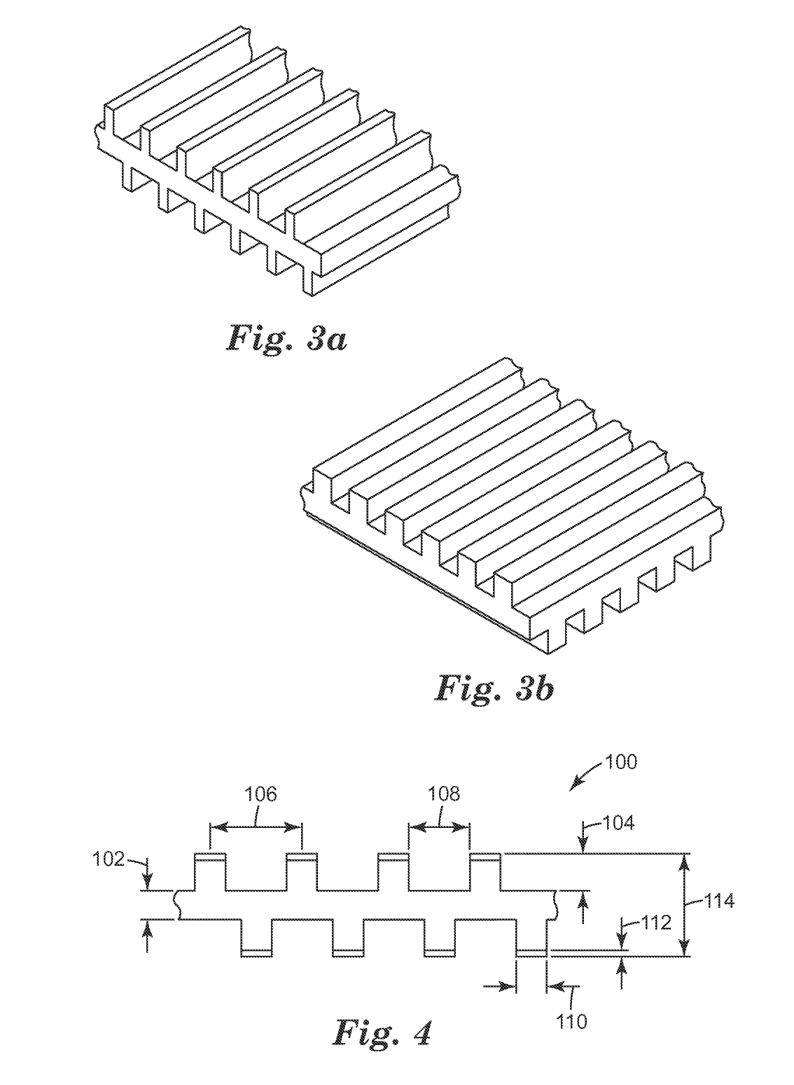

The support layer is manufactured to include at least a plurality of channels. FIGS. 2 and 3 depict three different embodiments of support membrane structures.

Shown in FIGS. 2a and 2b is a perspective and side view of support layer 50. Support layer 50 comprises a plurality of rails (54a, 54b, 54c . . . ) and flow channels (53a, 53b, 53c . . . ). The plurality of rails (54a, 54b, 54c . . . ) extend from the base of the support layer. In the present disclosure, the side of the rail (57) is substantially perpendicular to the base of rail 58. Substantially perpendicular means that the side of the rail is approximately 70 to 110 degrees relative to the base of the rail. The corners of the rails may be slightly rounded or misshapen due to manufacture.

The sides of two adjacent rails, 54a and 54b, form flow channel 53a, which is open to the outside of the membrane separation module. The flow channels have a flow direction. The arrow depicted in FIG. 2a shows the direction of flow.

Although the flow channels are depicted as linear, alternative shapes, sizes or configurations of the flow channels are permissible as long as the selectively permeable membrane is bonded along the distal surface of the support layer to form discrete flow channels. For example, the flow channels may have a tortuous path (e.g., a zig zag pattern) or a maze or curved configuration.

In addition to having just one major surface of the support layer comprising a plurality of rails as shown in FIG. 2a, both major surfaces of the support layer may comprise a plurality of rails as shown in FIGS. 3a and b.

In FIG. 3a, the support layer comprises a plurality of rails on each major surface, wherein the plurality of rails on the first major surface form a plurality of first flow channels with a first flow direction and the plurality of rails on the second major surface form a plurality of second flow channels with a second flow direction, wherein the net fluid flow in the second flow direction is substantially the same (i.e., less than 20, 10, or even 5 degrees different) as the net fluid flow in the first flow direction. In one embodiment, the rails of the first surface are aligned with the plurality of rails on the second surface as shown in FIG. 3a. In another embodiment, the rails of the first surface may be positioned in an offset relationship relative to the rails on the second surface.

In FIG. 3b, the support layer comprises a plurality of rails on each major surface wherein the plurality of rails on the first surface form a plurality of first flow channels with a first flow direction and the plurality of rails on the second surface form a plurality of second flow channels with a second flow direction, wherein the net fluid flow in the second flow direction is different (i.e., greater than 25, 45, or even 50 degrees) from the net fluid flow in the first flow direction. In one embodiment, the net fluid flow in the second flow direction is orthogonal (or about 90 degrees) from the net fluid flow in the first flow direction.

Shown in FIG. 4 is exemplary support layer 100, having a base layer thickness 102, total height tip to tip 114, a rail height 104, rail width 110, and a flow channel width 108 with a center-to-center spacing of 106 between adjacent rails. FIG. 4 depicts a multilayer support construction, wherein the thermoplastic polymer at the distal end of the rail has a thickness of 112. The width of the flow channels can vary depending on the application (e.g., the fluid used (liquid versus gas), the constituent being separated, and the complexity of the matrix being separated). In one embodiment, the width of the flow channel (108) is at least 100 μm, 200 μm, 250 μm, 300 μm, or even 500 μm; at most 1500 μm, 2000 μm, 5000 μm, 10000 μm, 15000 μm, 20000 μm, or even 25000 μm.

In one embodiment, the rail height (104) is at least 100 μm, 150 μm, 250 μm, 300 μm, or even 500 μm; at most 1000 μm, 1500 μm, 2000 μm, 2500 μm, or even 3000 μm. In one embodiment, the rail width (110 is at least 20 μm, 25 μm, 40 μm, 50 μm, 75 μm, or even 100 μm; at most 250 μm, 500 μm, 600 μm, 750 μm, or even 1000 μm. In one embodiment, the base layer thickness (102) is at least 100 μm, 150 μm, 250 μm, 300 μm, or even 500 μm; at most 1000 μm, 1500 μm, 2000 μm, 2500 μm, or even 3000 μm.

Shown in FIG. 2b, is thermoplastic polymer 59 located at the distal end of rails 54f and 54g. The thermoplastic polymer at the distal end of the rails can be used to bond or adhere the support layer to the selectively permeable membrane.

In one embodiment, the support layer, comprising the plurality of rails and channels, consists essentially of a thermoplastic polymer, meaning that the support layer is made from a polymer that melts or is able to be pliable upon heating and then retains a shape upon cooling.

The thermoplastic polymer may be selected from the group consisting of polypropylene and copolymers thereof, polyethylene and copolymers thereof, polyolefin elastomers, ethylene vinyl acetate copolymers, ethylene vinyl acetate terpolymers, styrene-ethylene/butylene-styrene block copolymers, polyurethanes, polybutylene (polyisobutylene), polybutylene copolymers, polyisoprene, polyisoprene copolymers, acrylate, silicones, natural rubber, and mixtures thereof.

Such thermoplastic polymers are commercially available, such as ultra low density polyethylene such as that available under the trade designation “ENGAGE” from DuPont Dow Elastomers, LLC of Wilmington, Del., and ethylene vinyl acetate copolymers and terpolymers such as that available under the trade designation “ELVAX” from Dupont Dow Elastomers, LLC.

In another embodiment, the support layer is a multilayer support, comprising at least two different polymer layers (i.e., a thermoplastic polymer and a second polymer). The thermoplastic polymer is as described above and the second polymer may be selected from the group consisting of: a thermoset polymer, a second thermoplastic polymer, or a blend of thermoset or thermoplastic polymers. In such an embodiment, the base of the support layer may comprise the second polymer, while the rails comprise the thermoplastic polymer. In another embodiment, the base and rails of the support comprise the second polymer, while the distal tips of the rails comprise the thermoplastic polymer (e.g., as shown in FIG. 2b).

If a multilayer support is used, typically, the thermoplastic polymer at the distal end has a softening point, or melting temperature, which is lower (e.g., at least 5° C., 10° C., 20° C., or even at least 50° C.) than the softening or melting temperature of the second polymer of the multilayer support.

In general, any suitable technique and apparatus for polymer processing into shapes, known in the art, may be used to prepare a polymeric support layer of the present invention. Such techniques include continuous processes such as profile extrusion, cast film extrusion, and cast and cure. Casting processes can utilize structured surfaces to replicate the rail shape. Non-continuous polymer processes such as injection molding and thermo-forming can also be used to form the rails.

If a multilayer support is used, the thermoplastic polymer may be extruded onto the distal end of at least a portion of the plurality of rails. In another embodiment, the thermoplastic polymer is coated onto the distal end of at least a portion of the plurality of rails and/or the support layer. Coating onto the distal end of the rail can be done by coating processes, which are well known in the art of polymer processing. For example, either hot-melt or solvent-based gravure coating could be used to coat a thin layer of thermoplastic polymer onto the distal ends.

When a multilayer support is used, the height of the thermoplastic polymer on the distal end of the rail must be substantial enough to provide sufficient bonding between the support and the selectively permeable membrane; typically at least 20 μm, 150 μm, 250 μm, 300 μm, or even 500 μm in height.

Layer

Each layer of the present disclosure comprises the selectively permeable membrane and at least 1, or even 2 support layers, such that there is a plurality of flow channels on both major surfaces of the selectively permeable membrane.

The selectively permeable layer is bonded to the support layer by the thermoplastic polymer. The thermoplastic polymer is located at least at the distal end of a rail. Preferably, a majority (75%, 90%, 95%, 99% or even 100%) of the rails comprise the thermoplastic polymer at least at the distal end. Further, the thermoplastic polymer should cover at least a portion or substantially covering (preferably covering at least 75, 90, 95, 99, or even 100%) of the entire length of the distal end of each of the rails. Preferably, the thermoplastic polymer extends along an entire distal edge surface of the rail to form a substantially continuous seal along the length of the channel walls.

The substantially continuous seals along two adjacent top surfaces of the rails (channel walls) and the selectively permeable membrane form a flow channel that is discrete and separate from adjacent flow channels. The bonding of the selectively permeable membrane along substantially all of the top surfaces of the channel walls in a substantially continuous sealing relationship provides mechanical strength to the membrane separation module, preventing bowing and/or failure of the membrane separation module when stress or pressure is applied to the outer surface of the module. The bonding of the selectively permeable membrane along substantially all of the top surfaces of the channel walls in a substantially continuous sealing relationship also localizes to that particular flow channel any rupture that may occur to the selectively permeable membrane, thereby preventing flooding of the entire membrane separation module.

Generally, sufficient heat and/or pressure is applied to partially or fully melt the thermoplastic polymer to form a thermal bond between the support layer and the selectively permeable membrane. The thermoplastic polymer typically has a lower softening temperature than the selectively permeable membrane. Any thermoplastic polymer can be used so long as a thermal bond between the support layer and the selectively permeable membrane forms without damage to the selectively permeable membrane.

The thermal fusion process can be done using any technique known in the art for melting thermoplastic polymers, including, for example, ultrasonic bonding, infrared/radiant heat, conduction or convective heating. The entire layer (or stack) can be heated (e.g., in an oven) to bond the support layer and the selectively permeable layer together or local heat can be provided (e.g., heated air flowed) through the flow channels to bond the support layer and the selectively permeable layer together. External pressure may be applied during the heating process to ensure contact of the distal end of the rails with selectively permeable membrane.

In one embodiment, the plurality of support layers and the plurality of selectively permeable membrane layers are stacked and placed in an oven. Generally temperatures are selected at or slightly higher than the melting temperature of the thermoplastic polymer at the distal end of the rails.

In another embodiment, through-air may be flowed through the flow channels of the support layer to bond the distal end of the rails with the selectively permeable membrane. In one embodiment, the air flow may be in one direction through the membrane separation module. If the membrane separation module comprises orthogonal flow channels, it may be preferred to flow heated air through both directions of flow channels, e.g., in a cross-flow direction. A cross-flow configuration may lower the temperature and/or pressure of the heated air at the inlet of the membrane separation module and/or reduce the time to bond the module as compared to using a single direction flow configuration. Generally the temperatures selected will be based on the selectively permeable membrane and the melting temperature of the thermoplastic polymer at the distal end of the rails. The pressure of the heated air at the inlet will be based on the size of the membrane separation module, the thermal properties of the thermoplastic polymer at the distal end of the rails, and the temperature of the heated air at the inlet among other things.

Membrane Separation Module

The membrane separation module of the present disclosure comprises a series of repeating layers, wherein each layer comprises a selectively permeable membrane and at least one support layer. Thus, the membrane separation module may comprise at least 2, 3, 4, 6, 8, 10, 15, 20, 25, 50, 100, 150 or even 200 or more of these layers.

The layers may be stacked directly upon one another to form the membrane separation module or a second material may be stacked between each layer to provide additional properties or capabilities, for example, additional support, prefilter, etc. Exemplary second materials include: metals, glass, ceramics, polymers and non-woven or woven fabric material.

The support layers may be stacked such that a plurality of flow channels on the support layer are oriented in at least 1 or even 2 different flow directions.

In one embodiment, a first layer has the plurality of flow channels oriented in a first flow direction, while a second layer has the plurality of flow channels oriented in a second flow direction, which is different from the first. In another embodiment, the layer comprises at least 2 support layers on opposite sides of the selectively permeable membrane, wherein the first support layer has a plurality of flow channels oriented in a first flow direction and the second support layer has a plurality of flow channels oriented in a second flow direction, which is different from the first flow direction. Such an embodiment is depicted in FIG. 1.

In one embodiment, the direction of net fluid flow between the first and second flow directions are substantially orthogonal (meaning between 45 to 135 degrees different; 70 to 110 degrees different; 80 to 100 degrees different; or even 85 to 95 degrees different), although other orientations may be contemplated.

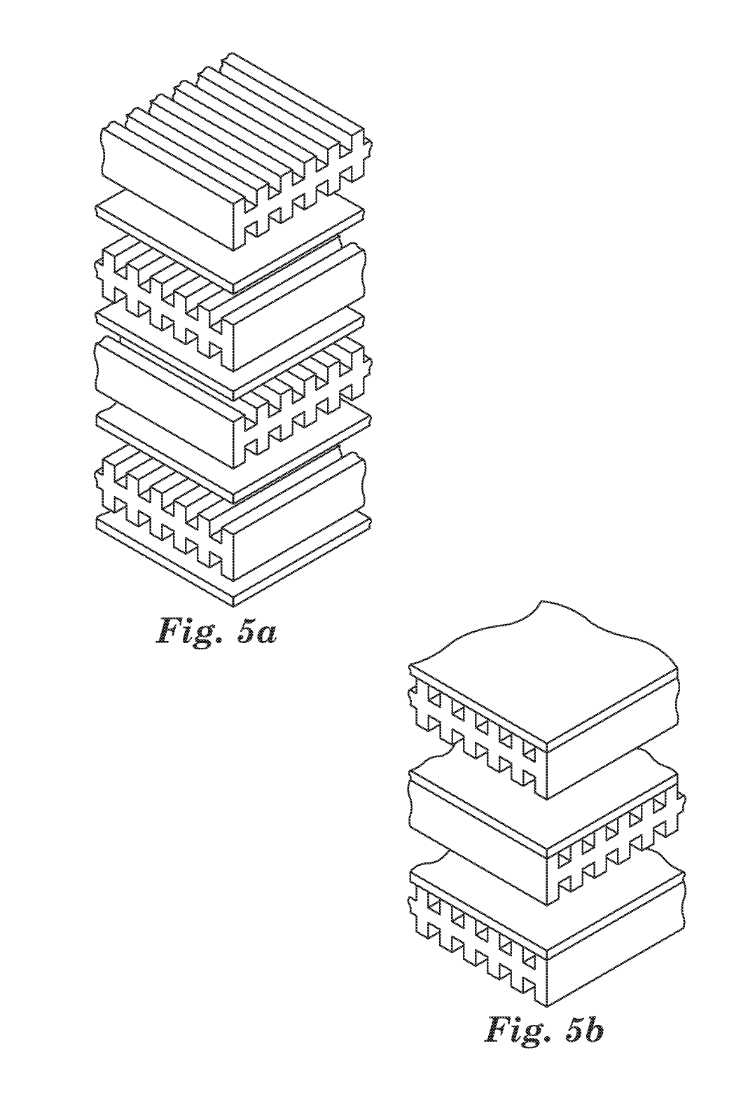

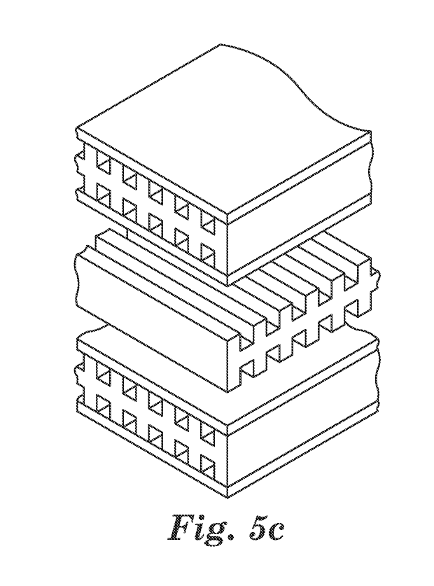

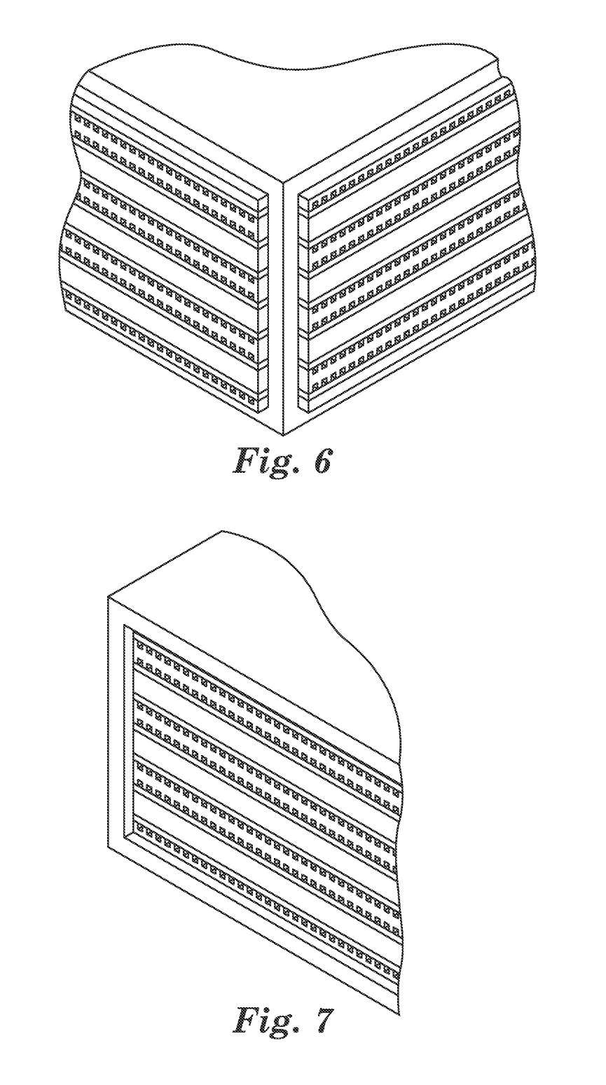

FIGS. 5a, 5b, and 5c depict different methods of assembling the membrane separation module of the present disclosure. In FIG. 5a, individual support layers and selectively permeable membranes are contacted together. The thermoplastic polymer at the distal end of the rails is subsequently heated to bond the support layers with the selectively permeable membranes forming the bonded stack. In FIG. 5b, a selectively permeable membrane is bonded to a major surface of a support to form a layer. A plurality of these layers are then stacked in alternating directions, such that the flow channels are orthoganol between adjacent layers and the stack is then bonded to form the membrane separation module. In FIG. 5c, a selectively permeable membrane is bonded to both major surfaces of a support to form a layer. Then a support is stacked between the layers and then bonded to form the membrane separation module.

At least one of the bonds in FIG. 5c comprises thermally bonding the support to the selectively permeable membrane via the thermoplastic polymer at the distal end of at least a portion of the plurality of rails on the support. The other bond could be also a thermoplastic, which is heated, or another type of adhesive (e.g., thermoset adhesive, reactive adhesive, or a pressure sensitive adhesive). In one embodiment, a support made of polypropylene is calendared between two sheets of a selectively permeable membrane, ECTFE (ethylene-chlorotrifluoroethylene copolymer, similar to the process as disclosed in U.S. Pat. No. 6,986,428 (Hester et al.)), to form a layer and then a second support having a thermoplastic polymer at the distal end of the plurality of rails is placed between the layers comprising ECTE/polypropylene/ECTFE and thermally treated to create the stack (i.e., the membrane separation module).

When formed, the membrane separation module has a first fluid inlet and at least two fluid outlets. In another embodiment, the membrane separation module comprises more than two fluid outlets.

In one embodiment, the membrane separation modules of the present disclosure may be scaled into units that are a couple of feet (or meters) in size. Advantageously, the membrane separation modules of the present disclosure may not only be scaleable, but also have dimensional stability and be resistant to mechanical deformation. For example one advantage of the present disclosure is that the support layer does not have to be unitary. In one embodiment, two (or more) sheets of support layer are placed next to one another on the selectively permeable layer. During the thermal treatment, the seam between the two adjacent support sheets may fuse together making a single support layer. This ability to patchwork sheets of the support layer together, would, for example, facilitate scale-up of a process since, e.g., you would not necessarily need a wider extrusion die to make a wider membrane separation module since you could patch multiple support sheets together to make a wider support layer. Further, as shown in the Example Section, the membrane separation modules of the present disclosure are able to withstand high loads.

The membrane separation module of the present disclosure can be used to treat waste water, filter particulates, and perform liquid/liquid, liquid/gas or gas/gas extraction.

Because the membrane separation module of the present disclosure is used in fluid applications with at least one fluid inlet and one fluid outlet, the various flow directions and inlets and outlets must be managed and isolated.

Two directional flow can be created in which a first fluid flows through the module in a first flow direction, passing through the flow channels and contacting the selectively permeable membrane. The permeate of interest (e.g., an analyte, liquid, particle, gas, or vapor) may pass through the selectively permeable membrane and into the flow channels on the other side of the selectively permeable membrane. For manufacturing and material handling ease, it is preferable that the flow channels, which collect the permeate run in a direction different than the feed fluid. Although in one embodiment, the direction of the permeate is the same as that of the feed fluid.

To prevent leakage, the membrane separation module can be fabricated to block the peripheral (or outer) flow channels.

In one embodiment, a material may be applied through at least one of the flow channels at the periphery or edges of the support layer. This material may be an adhesive or a thermoplastic polymer. Exemplary adhesive include hot melt adhesives, epoxy adhesives, urethane adhesives, acrylic adhesives, silicone adhesives, polyimide adhesives, plastisols, or polyvinyl acetate adhesives. Exemplary thermoplastic polymers include polypropylene, polyethylene, polybutylene, polyisoprene and polyolefin copolymers thereof.

Flow channel ends may be selectively heated to fuse the flow channel end and to provide a rigid mechanical frame, mounting surfaces and/or flow manifold mating surfaces for the membrane separation module. By sealing the corners and peripheral edges of the membrane separation module, fluid leaks and cross-contamination of fluids can be minimized, as well as provide a smooth surface for gasket seals or fluid manifold interfaces. In some embodiments, the sealing of the corners and peripheral edges of the membrane separation module also provide additional structural strength and/or provide a rigid mechanical framework to support the bonded stack. When at least a significant portion of the support layers are made of thermoplastic polymers, all or a portion of one or more faces of the membrane separation unit may be fused or “face melted” by pressing it against a heated plate or platen. In one embodiment, the edges are sealed using face melting or are fused as shown in FIG. 6. In another embodiment the flow channels and plurality of rails are recessed as shown in FIG. 7. This is accomplished by face melting or fusing the face of the membrane separation module and then cutting or milling a recess into the face.

The membrane separation module may be placed into a housing and/or connected with a fluid distribution cap to direct fluid into the membrane separation module and contain the fluid.

In many embodiments, the membrane separation module is designed and configured to fit into a frame or housing with manifolds on two, three or four (or more) sides (edge faces) of the membrane separation module. Fluids entering the housing on two orthogonal sides can distribute over all the layers at the entrance manifolds, pass through the membrane separation module and be collected in the exit manifolds. Seals may be formed along the edges and corners between the membrane separation module and the housing to prevent the fluids from bypassing the module and directly contacting one another. The seals can be, for example, a foam or soft rubber. Thus, contact between the at least two fluids of the membrane separation module occur only through the selectively permeable membrane. In some embodiments, the housing is rigid and the membrane separation module is fitted within the housing such that there is minimal expansion of the membrane separation module as fluid pressure is applied to it.

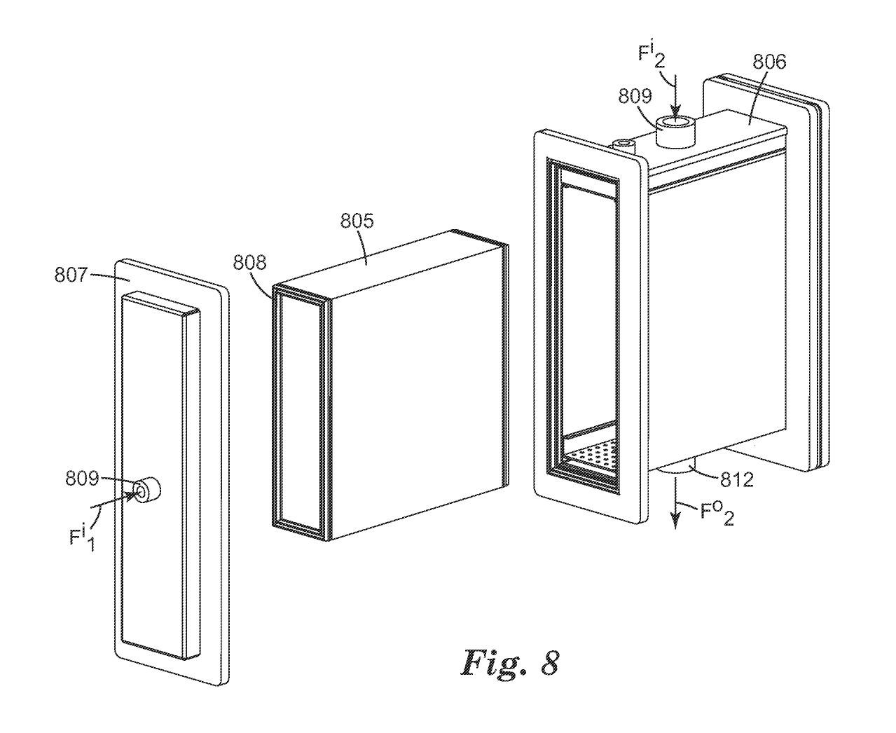

FIG. 8 is a schematic perspective view of an illustrative system comprising membrane separation module 805 disposed within a housing 806. Membrane separation module 805 comprises gaskets (e.g., 808) sealing the open channel faces of the membrane separation module and directing fluid flow. End plates (e.g., 807) are used to cover the end of housing 806 forming a system (or article) for performing separations. Port 809 in end plate 807 is used to input fluid (arrow Fⁱ₁ depicting fluid flow) into the system contacting one open channel surface of the membrane separation module 805. The F₁ fluid would pass through membrane separation module 805 and exit the opposing side of the system, not shown. A second fluid, F₂ enters housing 806 via port 809, passes through membrane separation module 805 and exits through port 812 as F°₂.

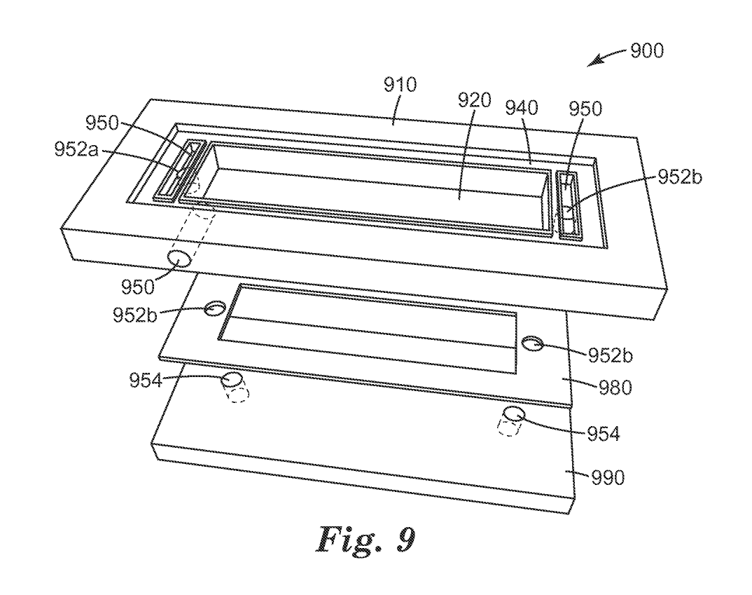

Shown in FIG. 9 is an exemplary embodiment of fluid distribution cap 900 that can be sealed onto a membrane separation module to form a separation system. Fluid distribution cap 900 consists of frame 910, gasket 980, and end plate 990. Frame 910 comprises opening 920 and recess 940. The membrane separation module fits into recess 940. Opening 920 acts as a fluid reservoir, holding fluid between the membrane separation module and end plate 990. Opening 920 is fluidly connected to port 950, which can be used as a fluid inlet or fluid outlet. Gasket 980 is used to seal end plate 990 to the frame 910. To form a separation system, the fluid distribution caps are placed on opposing open channel faces of the membrane separation module. If the membrane separation module comprises orthogonal flow channels, in one embodiment, two fluid distribution caps (900), may be place opposite one another on the membrane separation module, fluidly connected by one direction of flow channels, while a different style fluid distribution cap is placed on the adjacent sides of the membrane separation module fluidly connected by the orthogonal flow channels. In another embodiment, the membrane separation module comprising two opposing fluid distribution caps 900 may be placed into a reservoir to provide fluid to the orthogonal flow channels, or a fan may be used to provide air through the orthogonal flow channels.

Not only can fluid distribution cap 900 be used to distribute, for example, a fluid to be separated into the membrane separation module, it can also be used to seal the peripheral flow channels of the membrane separation module. Shown in FIG. 9 are reservoir 950, which is fluidly connected via openings 952a (in frame 910) and 952b (in gasket 980) to port 954 in end plate 990. In one embodiment, an adhesive or thermoplastic polymer may be introduced through port 954 and passed through the fluid distribution cap and into the peripheral flow channels of the membrane separation module.

Articles of the present disclosure include: a normal flow or tangential flow filtration device, a liquid/liquid contactor, a liquid/liquid extractor, a liquid/air contactor, a liquid gasification or de-gasification device, a gas-gas separation device, a membrane distillation device, a heat exchanger, or a combination thereof.

In one embodiment, a tangential flow liquid contactor, providing for crossflow contact of a liquid stream and a gas stream on opposing sides of a series of membranes may be constructed. Such a contactor might be useful, for example, for the dehumidification of a humid air stream, flowing through the contactor in a first flow direction, by transport of water vapor across a series of hydrophobic, microporous membranes and into a liquid desiccant solution flowing through the contactor in a second flow direction.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; Milwaukee, Wis., or known to those skilled in the art unless otherwise stated or apparent.

These abbreviations are used in the following examples: g=gram, hr=hour, in=inches, kg=kilograms, min=minutes, m=meter, cm=centimeter, mm=millimeter, ml=milliliter, L=liter, psi=pounds per square inch, MPa=megaPascals, and wt=weight.

Support Layer 1

A polypropylene/polyethylene impact copolymer (available as C104, 1.5 MFI, from Dow Chemical Corp., Midland, Mich., USA) was extruded with a 6.35 cm single screw extruder (24:1 length:diameter) at a rate of approximately 13.3 kg/hr using a barrel temperature profile that steadily increased from 204° C. to 260° C. The melt stream was fed to an Autoflex 4-H 40 extrusion die (Extrusion Dies, Inc. Chippewa Falls, Wis.) maintained at a temperature of 260° C. The extrudate was extruded vertically downward through the die equipped with a die lip having a shaping profile. After being shaped by the die lip, the extrudate was quenched in a water tank at a speed of approximately 1.5 m/min with the water being maintained at approximately 16° C. The die lip had an opening cut by electron discharge machining (EDM) configured to form a central polymeric sheet having a structured surface formed of evenly spaced linear rail protrusions extending perpendicularly from the base of the sheet on both sides (as shown in FIG. 3a).

This support layer had a plurality of rails (and thus flow channels) on both major surfaces. The support sheet had a base layer thickness of about 254 μm (0.010 in). The dimensions for each rail were approximately 965 μm (0.038 in) in height and approximately 305 μm (0.012 in) in width, and the rails had a center-to-center spacing of approximately 2311 μm (0.091 in).

Support Layer 2

A polypropylene impact copolymer (available under the trade designation “LYONDELLBASELL PRO-FAX 7523”, 4.0 MFI, LyondellBasell Industries, Houston, Tex.) and a thermoplastic polyolefin copolymer (available under the trade designation “DOW ENGAGE 8200”, 5.0 MFI, Dow Chemical Corp., Midland, Mich.) were coextruded to form a fluid impermeable support sheet made from the polypropylene copolymer having a flat base layer with rails on both sides, with the outer-most surface (“tips”) of the rails containing the lower melting point, thermoplastic polyolefin copolymer.

The polypropylene copolymer was extruded with a 6.35 cm single screw extruder (24:1 length/diameter) at a rate of approximately 54.0 kg/hr using a barrel temperature profile that steadily increased from 204° C. to 260° C. The polyolefin copolymer was fed at a rate of approximately 4.7 kg/h into a second single screw extruder having a diameter of approximately 3.81 cm (28:1 length/diameter) and a temperature profile that steadily increased from 204° C. to 260° C. Both polymers were fed into a 3 layer A-B-A coextrusion feedblock (Cloeren Co., Orange, Tex.) with the polypropylene copolymer forming the “B” layer and the polyolefin forming the two “A” layers. The 3-layer melt stream was extruded and shaped by a shaping die lip as described in the Support Layer 1 section above. The extrudate was then quenched in a water tank at a speed of approximately 3.0 m/min with the water being maintained at approximately 16° C.

This support layer had a plurality of rails on both major surfaces. The support has a base layer thickness of about 254 microns (0.010 in) and was composed of the polypropylene copolymer. Each rail extended continuously along the base layer. The dimensions for each rail were approximately 1118 microns (0.044 in) in height and approximately 279 microns (0.011 in) in width, and the rails had a center-to-center spacing of approximately 2311 microns (0.091 in). Each rail had a layer of approximately 203 microns (0.008 in) in thickness of the low melting point polyolefin copolymer at its distal end (“tip”). The dual sided support sheet comprised 8% by weight of the low melting polyolefin copolymer resin on the rail tips.

Support Layer 3

A polypropylene (PP) impact copolymer (available under the trade designation “LYONDELLBASELL PRO-FAX 7523”, 4.0 MFR, LyondellBasell Industries, Houston, Tex.) and a polyolefin (PO) copolymer (available under the trade designation “DOW AFFINITY PT1450G1”, 7.5 MI, 0.902 Density, Dow Chemical Corp., Midland, Mich.) were coextruded to form a fluid impermeable support sheet made from the PP having a flat base layer with rails, with the outer-most surface (“tips”) of the rails containing the lower melting point heat sealable thermoplastic polyolefin (PO) copolymer.

The PP was extruded with a 6.35 cm (2.5 in) single screw extruder (30:1 L/D) at a speed of 110 revolutions per minute (RPM) using a barrel temperature profile that steadily increased from 182° C. (360° F.) to 204° C. (400° F.). The PO was fed into a second single screw extruder having a diameter of approximately 3.18 cm (1.25 in) (30:1 L/D) at a speed of 15 RPM using a temperature profile that steadily increased from 179° C. (355° F.) to 204° C. (400° F.). Both polymers were fed into a 3-layer A-B-A coextrusion feedblock (Cloeren Co., Orange, Tex.) with the PP forming the “B” layer and the PO forming the two “A” layers. The 3-layer melt stream was extruded and shaped by a shaping die lip as described in the Support Layer 1 section above. The extrudate was then quenched in a water tank at a speed of approximately 3.0 m/min (10 ft/min) with the water being maintained at approximately 10° C. (50° F.).

This support layer had a plurality of rails on both major surfaces. The base layer of the support sheet had a thickness of about 203 microns (0.008 in) and was composed of the PP. Each rail extended continuously along the base layer. The dimensions for each rail were approximately 1029 microns (0.0405 in) in height. Each rail had a base layer thickness of approximately 203 microns (0.008 in) and the thickness of the PO at its distal end (“tip”) was approximately 127 microns (0.005 in). The center-to-center spacing was about 2184 micron (0.086 in) and the rail width was about 381 microns (0.015 in)

Selectively Permeable Membrane 1 (SPM 1)

This was an ethylene-chlorotrifluoroethylene (ECTFE) microporous membrane similar to that described in U.S. Pat. Publ. No. 2011/0244013 (Mrozinski, et al.). Thickness of approximately 48.3 microns (0.0019 in), porosity of approximately 69%, and a bubble point pore size of approximately 0.2 microns. The ECTFE membrane had a melting point higher than Support Layer 1.

Selectively Permeable Membrane 2 (SPM 2)

This was a polypropylene thermally-induced phase separated microporous membrane similar to that described in Example 1 of U.S. Pat. No. 7,157,093 (Kondo et al.). The membrane had a thickness of approximately 63.5 μm (0.0025 in), a porosity of approximately 70%, and a bubble point pore size of approximately 0.2 μm.

Selectively Permeable Membrane 3 (SPM 3)

This membrane was a perforated film made of polypropylene was produced as described in U.S. Pat. Appl. No. 61/285,102 (Scheibner et al.). The film had 125 μm sized holes, approximately 12,000 holes per square inch (1860 holes per square cm), and approximately 25% open area.

Selectively Permeable Membrane 4 (SPM 4)

This membrane is an apertured film as described U.S. provisional patent application 61/615,676, Films and Methods of Making the Same, filed Mar. 26, 2012. As described in one example, polypropylene film was produced with the cross direction hole size of 10 μm and the machine direction hole size of 75 μm, and a film caliper of 110 μm.

Selectively Permeable Membrane 5 (SPM 5)

This membrane was a Reemay nonwoven polyester fiber media (produced by Fiberweb PLC, Old Hickory, Tenn., USA, comprising continuous filaments of high temperature resistant polyethylene terephthalate (PET).

Selectively Permeable Membrane 6 (SPM 6)

This membrane was a polypropylene thermally-induced phase separated microporous membrane similar to that described in Example 2 of U.S. Pat. No. 7,157,093 (Kondo et al.) without the addition of the blue pigment. The membrane had a thickness of approximately 76.2 μm (0.003 in), a porosity of approximately 35%, and a bubble point pore size of approximately 0.3 μm.

A roll of Support Layer 1 was placed on a portable unwind station with an air brake to provide tension. Support Layer 1 was unwound and fed horizontally into a nip formed between two 38.1-cm (15-in) diameter heated nip rolls placed vertically with respect to one another. The two nip rolls were heated to 163° C., and a nip force of approximately 1.1 kN (kiloNewtons) was applied and a gap was set between the nip rolls approximately 127 μm (0.005 in) less than the total thickness of the support sheet.

A first roll of SPM 1 was unwound using a clutch to provide tension, and contacted the top nip roll at a 12 o'clock position on the roll. A second roll of the SPM 1 was unwound using a clutch to provide tension, and contacted the bottom nip roll at a 6 o'clock position on the roll. Each membrane then maintained contact with a heated roll for 180 degrees of wrap before joining Support Layer 1 in the nip between the two heated rolls. The three-layer laminate (SPM 1/Support Layer 1/SPM 1) was withdrawn from the nip at a speed of approximately 1.5 m/min. A strong bond of SPM 1 to Support Layer 1 resulted.

Layer 2

A roll of Support Layer 2 was placed on a portable unwind station with an air brake to provide tension. A roll of SPM 2 was unwound using a clutch to provide tension to the film.

A series of idler rolls were used to establish a web path such that SPM 2 and Support Layer 2 made contact at a 2 o'clock position on a 30.5 cm (12 in) diameter chrome plated first nip roll. The nip roll was heated to approximately 85° C. The tips of the rails located on the bottom surface of Support Layer 2, comprising the low melting point resin, made contact with SPM 2 with lamination occurring in about 60 degrees of wrap around the heated nip roll.

A second 30.5 cm (12 in) diameter chrome plated nip roll was located directly adjacent the first nip roll. The second roll was heated to approximately 85° C. Both rolls were nipped together with a pressure of approximately 414 kPa (60 psi), using a gap setting of approximately 254 μm (0.010 in) less than the total thickness of the support sheet.

A second roll of SPM 2 was unwound using a clutch to provide tension and fed into the nip between the two nip rolls such that the tips of the rails located on the top surface of the support sheet made contact with the second SPM 2 at approximately a 3 o'clock position of the second nip roll. The three-layer laminate construction (SPM 2/Support Layer 2/SPM 2) continued to make contact for approximately 90 degrees of wrap around the second nip roll, and was withdrawn from the nip at a speed of approximately 1.5 m/min. A strong bond of the microporous membranes to the dual-sided support structure resulted.

Layer 3

SPM 3 and Support Layer 3 were laminated using an infrared (IR) heating process. Rolls of SPM 3 and Support Layer 3 were unwound, and an IR lamp was used to pre-heat the surfaces to be bonded just before the two films passed through a constant-pressure nip, prior to being collected via a surface winder, allowing for directed heating that does not require the heating of the membrane to the temperature of the lower melting polymer.

Describing the process in more detail, a roll of Support Layer 3 was placed on a portable unwind station and was unwound and fed horizontally, contacting the bottom roll (at a 6 o'clock position on the roll) of a calender nip formed between two 30.5 cm (12 in) diameter heated nip rolls placed vertically with respect to one another. The top nip roll was rubber coated and heated to 113° C. (235° F.) and the bottom nip roll was steel surfaced and temperature controlled to 21° C. (70° F.), and a nip force of approximately 1.3 IN per 2.54 cm (300 lbs per inch) was applied and a gap was set between the nip rolls approximately equal to the total thickness of the support sheet. The Support Layer 3 was pre-heated by a 1600 W Chromalox I.R. heater (Chromalox, Pittsburgh, Pa.) placed approximately 2 cm from the support layer at the 10 o'clock position on the bottom roll.

SPM 3 was unwound using a clutch to provide tension, and contacted the top roll at the 7 o'clock position on the top roll. A two-layer laminate (SPM 3/Support Layer 3) was withdrawn from the nip at a speed of approximately 1.2 m/min. A strong bond of SPM 3 to Support Layer 3 resulted.

Layer 4

The procedure as described in Layer 3 above was repeated except that SPM 5 was used instead of SPM3. A two-layer laminate (SPM 5/Support Layer 3) with a strong bond of SPM 5 to Support Layer 3 resulted.

Layer 5

The procedure as described in Layer 3 above was repeated except that SPM 6 was used instead of SPM 3. A two-layer laminate (SPM 6/Support Layer 3) was with a strong bond of SPM 6 to Support Layer 3 resulted.

Face Sealing a Membrane Separation Module: Method 1

One lateral face (Face 1) of a substantially thermoplastic membrane separation module was placed onto an aluminum plate that was laid upon a heated laboratory hotplate. The module was heated until Face 1 melted and stuck to the aluminum plate. The module and plate were then picked up and placed on a sheet of cool metal to quench the thermoplastic. The process was repeated on the face of the opposite side (Face 2). Then a third lateral face (Face 3, adjacent to Faces 1 and 2) was “face melted,” followed by face melting the face of the opposite side (Face 4). The center portions of each of the fused faces (Faces 1, 2, 3, and 4) were then removed to a depth of about 0.125-0.5 in (0.635-1.27 cm), using a milling machine (Bridgeport Milling Machines, Hardinge Inc., Elmira, N.Y.), thus exposing the unfused flow channels within and leaving flat peripheral surfaces on each face as depicted in FIG. 7. A border of ˜0.5 in (˜1.27 cm) on the long sides and 0.75-1.0 in (1.91-2.54 cm) on the short sides was left in order to provide a structural frame and gasket sealing surfaces for the membrane separation module.

Face Sealing a Membrane Separation Module: Method 2

The membrane separation module from Example 5 below was placed into a heat sealing apparatus. The heat sealing apparatus had a vertically mounted heated plate as well as a raised flat heated sealing surface that was attached to the heated plate and shaped to contact the periphery of a lateral face of a membrane separation module when the element was inserted into a movable holding fixture on the heat sealing apparatus. A plate comprising a window having an opening ¼ inch (0.6 cm) smaller than that of the membrane separation module was heated to 450° F. (232° C.) and one lateral face of the membrane separation module was pressed against the heated sealing surface with a force of about 60 lbs (267 N) for about 4 minutes until about 0.25 in (0.6 cm) of melting occurred. This heat sealing process melted the periphery of the channels in the membrane separation module (about 0.6 cm along all sides of the membrane separation module) and provided a smooth sealing surface which allowed water-tight sealing with a rubber gasket. The melting process was repeated on the opposing face of the membrane separation module, then on a third lateral face, and finally on the opposing remaining face. This produced a structural frame in the membrane separation module, as well as providing a gasket sealing surface on each of the four faces that had flow channel entrances/exits, as shown in FIG. 6.

Method of Assembly of a Flow Frame

Two fluid distribution caps as shown in FIG. 9 were attached to opposing sides of the membrane separation module that is described in Example 1 below. The fluid distribution cap 900 comprised an acrylonitrile-butadiene-styrene frame 910, a polyurethane gasket 980, and a polycarbonate end plate 990. Curable epoxy adhesive (available under the trade designation “3M SCOTCH-WELD DP-100 CLEAR EPOXY ADHESIVE” from 3M Co., St. Paul, Minn.) was introduced via ports 954 on one of the fluid distribution caps and pushed through the peripheral flow channels, forming a continuous bond about the periphery of the two sides of the membrane separation module. Using a similar process, the curable epoxy adhesive was applied to the peripheral flow channels on the adjacent sides of the membrane separation module.

The adhesive bonds were allowed to cure for approximately 24 h at room temperature. Fittings were placed on each of the ports and flexible tubing was attached to each fitting. The two adhesive injection ports (952a and 952b in FIG. 9) in one of the frames 910 were defined as inlet ports, while the two adhesive injection ports on the opposing frame were defined as outlet ports. Similarly, the adhesive injection ports on the two adhesive injection manifolds on one side of the membrane separation module were defined as inlet ports, while the adhesive injection ports on the two opposing adhesive injection manifolds were defined as outlet ports.

An excess volume of a low viscosity, two-part epoxy (MAX 1618 Clear Impregnating Resin, Polymer Products-CA, Ontario, Calif.) was mixed in a volumetric ratio of 2 parts “A” (resin) to 1 part “B” (curing agent). Using a peristaltic pump, the mixed epoxy was then pumped into each of the four inlet ports at a rate of approximately 5.5 mL/min. Pumping was continued until epoxy was seen emerging from each of the four outlet ports. The pump was then stopped, and the epoxy was allowed to cure for approximately 24 h at room temperature. The flexible tubing connections were then broken away from the membrane element.

The gaskets 980 and end plates 990 were attached to each of the two opposing frames 910 by means of ten sets of nuts and bolts. The nuts were tightened until complete compression of each of the gaskets was observed. Together, each frame, gasket, and end plate formed a liquid distribution pocket 920, and both opposing liquid distribution pockets were in fluid communication with opposing ends of one set of flow channels of the membrane separation module. A 1/8-inch NPT barb fitting was attached to each of the two liquid injection ports 950, and flexible tubing was attached to each barb fitting.

### EXAMPLE 1

Type 1 sheet: Layer 1 was die cut into square sheets measuring 21.59 cm (8.5 in) on each side. Type 2 sheet: Support Layer 2 was die cut into square sheets of having the same dimensions. Note that the distal ends of the rails on Support Layer 2 comprised a lower melting thermoplastic then Layer 1.

Alternating sheets of type 1 and type 2 were stacked vertically in a stacking fixture, such that the rails of the alternating type 1 and type 2 sheets ran in directions orthogonal to one another. Approximately 35 total sheets were placed into the fixture to form a stack approximately 7.62 cm (3 in) tall. A 1.27-cm (0.5-in) thick aluminum plate was then placed on top of the stack of sheets, and a 40.8-kg (90-lb) weight was placed on top of the aluminum plate and then bonded using the following heated air method as follows. The stacking fixture was outfitted with vertical air distribution plates on two adjacent sides, each positioned to distribute an air stream down the flow channels formed by the rails of the support sheets. Hot air was provided to the air distribution plates by means of an air blower outfitted with a resistance heater. Air at a temperature of 127° C. was blown simultaneously down each set of orthogonally oriented channels at a rate of 0.7 m³/min (25 ft³/min) for 25 min. Room temperature air was then blown down each set of channels at the same rate for 25 min, after which the air was turned off, the weights were removed, and the stack was removed from the fixture.

As a result of the hot air exposure, the stacked sheets were thermally fused into a membrane separation module approximately 6.99 cm (2.75 in) in height. The membrane separation module described above was then placed into the “Method of assembly of a flow frame” described above. The tangential flow liquid contactor was placed in a lab bench with one header assembly positioned on the bottom and the other header assembly positioned on the top. Compressed air was used to pressurize a reservoir containing water, which supplied water to the liquid injection port on the bottom of the tangential flow liquid contactor. A pressure transducer was positioned between the reservoir and the liquid injection port on the bottom of the liquid contactor. Tubing attached to the top liquid injection port was run to drain. The reservoir pressure was increased until the pressure transducer read 20.7 kPa (3 psi), and water was observed exiting the top liquid injection port. Other than the steady outlet flow of water from the top liquid injection port, no leaks of water from the tangential flow liquid contactor were observed.

### EXAMPLE 2

Type 3 sheet: Layer 2 was die cut into square sheets measuring 21.59 cm (8.5 in) on each side. Type 2 sheet: Support Layer 2 was die cut into square sheets having the same dimensions.

Alternating sheets of type 3 and type 2 were stacked vertically in a stacking fixture, such that the rails of the alternating type 3 and type 2 sheets ran in directions orthogonal to one another. Approximately 35 total sheets were placed into the fixture to form a stack approximately 7.62 cm (3 in) tall. A 1.27 cm (0.5 in) thick aluminum plate was then placed on top of the stack of sheets, and a 40.8 kg (90 lb) weight was placed on top of the aluminum plate and then bonded using the heated air method as described in Example 1.

As a result of the hot air exposure, the stacked sheets were thermally fused into a membrane separation module approximately 6.99 cm (2.75 in) in height.

### EXAMPLE 3

Layer 3 was die cut into square sheets 100 mm×100 mm (4 in×4 in). The square sheets were stacked in a metal fixture, such that the rails between adjacent layers ran in directions orthogonal to one another (i.e., each layer was rotated 90° when stacked). The stacked assembly was weighted with a metal plate and an additional weight to hold the sheets in compression and then the entire assembly was placed into an oven heated to 120° C. (248 F) overnight and then cooled and removed from metal fixture resulting in a unitary separation element.

### EXAMPLE 4

The same procedure as described in Example 3 was repeated except Layer 4 was used instead of Layer 3.

### EXAMPLE 5

Layer 5 was die cut into square sheets measuring 21.6 cm (8.5 in) on each side. The square sheets were stacked in a metal fixture, such that the rails between adjacent layers ran in directions orthogonal to one another. Approximately 32 total sheets were placed into the fixture to form a stack approximately 7.62 cm (3 in) in height. A 1.27 cm (0.5 in) thick aluminum plate was then placed on top of the stack of sheets, and approximately 40.8 kg (90 lb) weight was placed on top of the aluminum plate and then bonded using the heated air method as described in Example 1.

As a result of the hot air exposure, the stacked sheets were thermally fused into a membrane separation module approximately 6.35 cm (2.5 in) in height.

The membrane separation module was then face melted using the process as described in the “Face Sealing a Membrane Separation Module: Method 2”, above.

The “face melted” unitary membrane element above, which could be used as a tangential flow liquid contactor, was placed in leak test apparatus with two gaskets, one placed on each opposing end of the contactor with the gasket mated to the smooth sealing surface. Water was supplied at a rate of 700 ml/min to one end of the contactor and exited the opposite end. A pressure transducer was positioned between the reservoir and the liquid injection port on the entrance to the liquid contactor. Tubing attached to the exit injection port was run to a drain. Other than the steady outlet flow of water from the exit liquid injection port, no leaks of water from the tangential flow liquid contactor were observed.

Force Required to Buckle

The force required to buckle four different constructions was compared. Each construction tested was 8 in×8 in (20 cm×20 cm) or cut to 8 in×8 in, although the thicknesses varied as described below. Each sample was placed such that the major faces of the sample were parallel with the ground and compression was applied on two opposing sides (not the major faces) of the sample. Load was added until buckling of the sample was observed.

### Comparative Example A (CE A)

A polypropylene film having a nominal thickness of 0.076 millimeters (0.003 inches) was embossed into a corrugated film having 1.27 millimeter (0.05 inch) deep channels with a channel spacing of 3.56 millimeters (0.14 inches). A web of spun bond polypropylene (16.96 grams per square meter (0.5 ounces per square yard)), available from Hanes Companies, Inc., Conover, N.C.) was sonically sealed to the ridges of one side of the corrugated film at intervals of 1.59 millimeters (0.063 inches). The spun bond side of this sonically sealed pair was laminated to a microporous polypropylene membrane having an average pore size of approximately 0.35 micrometers (prepared as described in U.S. Pat. Nos. 4,726,989 and 5,120,594) using a hot melt web adhesive (PE-85-20, manufactured by Bostik, Inc., Wauwatosa, Wis.) to form a layer pair. (First layer pair 110 as described in Example 1 of U.S. Pat. No. 7,794,593 (Schukar et al.)) Compression was applied perpendicular to the direction of the corrugations.

### Comparative Example B (CE B)

Membrane stack made as described in Example 1 of U.S. Pat. No. 7,794,593 (Schukar et al.) with 32 layers of the corrugated polypropylene/microporous polypropylene layer stacked and bonded as shown in FIG. 1 with adhesive on edges.

### Comparative Example C (CE C)

Layer 5 as described above. Compression was applied perpendicular to the direction of the rails.

TABLE 1

| Example | Load added before buckling |
|---|---|
| CE A | ~10 g |
| CE B | ~300 g |
| CE C | ~30 g |
| 5 | >100,000 g |

As shown in Table 1, the single layer constructions comprising a support layer having a plurality of rails comprising a thermoplastic and a selectively permeable membrane bonded together (CE C) can handle more load than a single layer construction comprising a corrugated support layer sonically sealed and laminated to a selectively permeable membrane (CE B). When these single layer constructions are stacked and bonded together, the membrane separation module of the present disclosure (Example 5) can handle a significantly larger load (>100,000 g) as compared to CE B, which comprises the same number of layers.

Foreseeable modifications and alterations of this invention will be apparent to those skilled in the art without departing from the scope and spirit of this invention. This invention should not be restricted to the embodiments that are set forth in this application for illustrative purposes. To the extent that there is a conflict or discrepancy between this specification and the disclosures incorporated by reference herein, this specification will control.

1. A membrane separation module comprising:
a series of repeating layers, each layer comprising
(a) a selectively permeable membrane; and
(b) at least one support layer, wherein the support layer comprises a plurality of flow channels and a plurality of rails extending from the support layer, wherein the sides of two adjacent rails form a flow channel, wherein the plurality of rails on the support layer comprise a thermoplastic polymer at the distal end of at least a portion of the plurality of rails, and wherein the distal end of the plurality of rails contacts the selectively permeable membrane to form a bonded stack.

2. The membrane separation module of claim 1, wherein each layer comprises at least two support layers.

3. The membrane separation module of claim 1, wherein a plurality of flow channels on the support layer are oriented in a flow direction and wherein the membrane separation module comprises a first flow direction and a second flow direction, wherein the second flow direction is different from the first flow direction.

4. The membrane separation module of claim 3, wherein the first and second flow directions are substantially orthogonal.

5. The membrane separation module of claim 1, wherein the support layer comprises a plurality of rails on each major surface wherein the plurality of rails on the first surface form a first flow direction and the plurality of rails on the second surface form a second flow direction, wherein the second flow direction is different from the first flow direction.

6. The membrane separation module of claim 1, wherein the support layer comprises a plurality of rails on each major surface wherein the plurality of rails on the first surface form a first flow direction and the plurality of rails on the second surface form a second flow direction, wherein the second flow direction is substantially the same as the first flow direction.

7. (canceled)

8. The membrane separation module of claim 1, wherein the support layer comprises two different materials, wherein at least one of the materials is the thermoplastic polymer at the distal end of at least a portion of the plurality of rails.

9. The membrane separation module of claim 8, wherein the second material is selected from the group consisting of: a thermoset polymer, a second thermoplastic polymer, or a blend of thermoset polymers.

10. The membrane separation module of claim 1, wherein in at least a portion of the plurality of rails, each of the sides of each of the rails is substantially perpendicular to the base of the corresponding rail.

11. The membrane separation module of claim 1, wherein the membrane separation module has a first fluid inlet and a first fluid outlet.

12. The membrane separation module of claim 1, wherein the membrane separation module has a second fluid outlet.

13. The membrane separation module of claim 1, wherein the membrane separation module comprises at least 2 fluid outlets.

14. (canceled)

15. The membrane separation module of claim 1, wherein the selectively permeable membrane is a microperforated polymeric film comprising: (i) opposed first and second surfaces separated by a first certain distance; and (ii) a plurality of channels perpendicular to the first and second surfaces, wherein a first opening of each channel intersects the first surface and a second opening of each channel intersects the second surface; wherein the diameter of the first opening is larger than the diameter of the second opening and the second openings on the second surface are spaced apart by a second certain distance; wherein the ratio of the first certain distance to the second certain distance is at least 0.25; and further wherein the second surface has an open area of at least 10%.

16. The membrane separation module of claim 1, wherein the selectively permeable membrane comprises (i) opposed first and second surfaces; and (ii) a plurality of channels perpendicular to the first and second surfaces, wherein a first opening of each channel intersects the first surface and a second opening of each channel intersects the second surface; wherein the diameter of the first opening is larger than the diameter of the second opening; wherein the second surface has an open area of at least 20%; and further wherein the second surface comprises at least 6,000 openings per square inch.

17-18. (canceled)

19. A method of making an article comprising:
(a) providing a selectively permeable membrane and at least one support layer, wherein the support layer comprises a plurality of flow channels and a plurality of rails extending from the support layer, wherein the sides of two adjacent rails form a flow channel, wherein the plurality of rails on the support layer comprise a thermoplastic polymer at the distal end of at least a portion of the plurality of rails;
(b) contacting the distal end of the plurality of rails to the selectively permeable membrane to form a layer;
(c) stacking a plurality of the layers; and
(d) applying heat to bond the distal end of the plurality of rails to the selectively permeable membrane.

20. (canceled)

21. The method of claim 20, wherein a plurality of flow channels on the support layer are oriented in a flow direction and wherein the membrane separation module comprises a first flow direction and a second flow direction, wherein the second flow direction is different from the first flow direction and the heated fluid is passed through the plurality of flow channels in a cross-flow direction.

22. The method of claim 19, wherein the thermoplastic polymer is extruded onto the distal end of at least a portion of the plurality of rails.

23. The method of claim 19, wherein the thermoplastic polymer is coated onto the distal end of at least a portion of the plurality of rails.

24. The method of claim 19, further comprising applying a third material through at least one of the flow channels at the periphery of the support layer.

25-26. (canceled)

27. The method of claim 19, wherein the bonded stack is face melted or fused together.

28. (canceled)
